(19) United States
(12) Patent Application Publication
(10) Pub. No.: US 2016/0231471 A1
(43) Pub. Date: Aug. 11, 2016

(54) INTEGRATED DIFFUSER WITH VARIABLE-INDEX MICROLENS LAYER

(71) Applicant: QUALCOMM MEMS Technologies, Inc., San Diego, CA (US)

(72) Inventors: Jian Jim Ma, San Diego, CA (US); Yaoling Pan, San Diego, CA (US); Jyothi Karri, San Jose, CA (US); Sapna Patel, Fremont, CA (US)

(21) Appl. No.: 14/616,476

(22) Filed: Feb. 6, 2015

(51) Int. Cl. G02B 5/02; G02B 3/00

(52) U.S. Cl. CPC G02B 5/021; G02B 3/0037

(57) ABSTRACT

An apparatus may include a first layer having a range of first layer indices of refraction. The range of first layer indices of refraction may include at least two indices of refraction. The apparatus may include a second layer proximate the first layer. The second layer may have a second index of refraction that is outside (e.g., lower than) the range of first layer indices of refraction. An interface between the first layer and the second layer may include an array of microlenses of substantially randomized sizes. The microlenses may include sections of features that are substantially spherical, polygonal, conical, etc. According to some implementations, the first and second layers may be disposed between an array of display device pixels and a substantially transparent substrate, such as a glass substrate, a polymer substrate, etc.

### TECHNICAL FIELD

This disclosure relates to diffuser stacks, particularly diffuser stacks suitable for display devices.

### DESCRIPTION OF THE RELATED TECHNOLOGY

Electromechanical systems (EMS) include devices having electrical and mechanical elements, actuators, transducers, sensors, optical components (e.g., mirrors) and electronics. EMS can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term IMOD or interferometric light modulator refers to a device that selectively absorbs and/or reflects light using the principles of optical interference. In some implementations, an IMOD may include a highly reflective metal plate and a partially absorptive and partially transparent and/or reflective plate, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the IMOD and the reflection spectrum. IMOD devices have a wide range of applications, and are anticipated to be used in improving existing products and creating new products, especially those with information display capabilities.

In reflective displays such as interferometric modulator (IMOD) displays, it can be advantageous to include a diffuser layer or stack. Such diffusers can improve the viewing angle of a display device. Also, reflective displays including IMOD displays may have specular reflections of light sources that can appear as glare and thereby degrade the image shown on the display, and diffusers can reduce such specular reflections.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a first layer and a second layer proximate the first layer. The first layer may have a range of first layer indices of refraction. In some examples, the range may include at least two indices of refraction. According to some implementations, the first layer may have a graded index of refraction. The second layer may have a second layer index of refraction that is outside of the range of first layer indices of refraction. In some examples, the second layer index of refraction may be lower than the range of first layer indices of refraction. However, in alternative examples, the second layer index of refraction may be higher than the range of first layer indices of refraction. Some implementations may include a conformal anti-reflective layer between the first layer and the second layer.

An interface between the first layer and the second layer may, in some examples, include an array of microlenses of substantially randomized sizes and/or locations. In some implementations, the microlenses may include portions of the second layer that extend into the first layer. According to some examples, each microlens may have an apex area of maximum extent into the first layer and lateral areas adjacent the apex area. According to some implementations, a first layer index of refraction adjacent the apex area may be different from a first layer index of refraction adjacent at least a portion of the lateral areas. In some such implementations, a difference of index of refraction between the first layer and the second layer may be relatively higher in the apex area than in at least a portion of the lateral areas.

In some implementations, the first layer may have a first side proximate the second layer and a second side opposite the second layer. Surface angles of microlenses may, for example, be measured from an axis normal to the second side of the first layer to a normal from a microlens surface. According to some such implementations, a difference of index of refraction between the first layer and the second layer may be relatively higher for lower-angled microlens surfaces, relative to a difference of index of refraction between the first layer and the second layer for higher-angled microlens surfaces. In some implementations, the lower-angled microlens surfaces have surface angles between zero and a threshold angle.

In some examples, the apparatus may include an array of pixels proximate the second layer. Some such examples may include a substantially transparent substrate proximate the first layer. Some implementations may include a cladding layer between the substantially transparent substrate and the first layer. According to some such implementations, the cladding layer may have a cladding layer index of refraction that is lower than the range of first layer indices of refraction.

According to some implementations, the substantially transparent substrate may be capable of functioning as a light guide. In some such implementations, the light guide may include a plurality of light-extracting features capable of extracting light from the light guide. The light-extracting features may be capable of capable of providing at least a portion of the extracted light to the array of pixels.

Some innovative aspects of the subject matter described in this disclosure can be implemented in a method of forming a diffuser stack. The method may involve forming, on a substantially transparent layer, a first layer having a range of first layer indices of refraction. In some implementations, the range may include at least two indices of refraction. According to some such implementations, the method may involve forming the first layer with a graded index of refraction. The method may involve etching trenches into the first layer. In some examples, the trenches may have substantially random sizes and locations.

According to some implementations, the method may involve depositing a second layer proximate the first layer, to form an array of microlenses of substantially randomized sizes and/or locations. The second layer may have a second layer index of refraction that is outside of the range of first layer indices of refraction. In some examples, the second layer index of refraction may be lower than the range of first layer indices of refraction. However, in alternative examples, the second layer index of refraction may be higher than the range of first layer indices of refraction. Some implementations may include disposing a conformal anti-reflective layer between the first layer and the second layer.

In some implementations, the microlenses may include portions of the second layer that extend into the first layer. According to some examples, each microlens may have an apex area of maximum extent into the first layer and lateral areas adjacent the apex area. According to some implementations, a first layer index of refraction adjacent the apex area may be different from a first layer index of refraction adjacent at least a portion of the lateral areas. In some such implementations, a difference of index of refraction between the first layer and the second layer may be relatively higher in the apex area than in at least a portion of the lateral areas.

In some implementations, the first layer may have a first side proximate the second layer and a second side opposite the second layer. Surface angles of microlenses may, for example, be measured from an axis normal to the second side of the first layer to a normal from a microlens surface. According to some such implementations, a difference of index of refraction between the first layer and the second layer may be relatively higher for lower-angled microlens surfaces, relative to a difference of index of refraction between the first layer and the second layer for higher-angled microlens surfaces. In some implementations, the lower-angled microlens surfaces have surface angles between zero and a threshold angle.

Some innovative aspects of the subject matter described in this disclosure can be implemented in one or more non-transitory media having software stored thereon. Such non-transitory media may, for example, include random access memory (RAM), read-only memory (ROM), electrically erasable programmable read-only memory (EEPROM), compact disk read-only memory (CD-ROM) or other optical disk storage, magnetic disk storage or other magnetic storage devices, or any other medium that may be used to store desired program code in the form of instructions or data structures and that may be accessed by a computer. In some examples, the software may include instructions for controlling one or more device to form a diffuser stack.

According to some implementations, the software may include instructions for forming, on a substantially transparent layer, a first layer having a range of first layer indices of refraction. The range may include at least two indices of refraction. In some examples, the software may include instructions for forming the first layer with a graded index of refraction.

The software may include instructions for etching trenches into the first layer. The trenches may have substantially random sizes and/or locations. In some examples, the software may include instructions for depositing or coating a second layer proximate the first layer, to form an array of microlenses of substantially randomized sizes and locations. The second layer may have a second layer index of refraction that is outside of the range of first layer indices of refraction. According to some implementations, the software may include instructions for disposing a conformal anti-reflective layer between the first layer and the second layer.

In some implementations, the microlenses may include portions of the second layer that extend into the first layer. According to some examples, each microlens may have an apex area of maximum extent into the first layer and lateral areas adjacent the apex area. According to some implementations, a first layer index of refraction adjacent the apex area may be different from a first layer index of refraction adjacent at least a portion of the lateral areas. In some such implementations, a difference of index of refraction between the first layer and the second layer may be relatively higher in the apex area than in at least a portion of the lateral areas.

In some implementations, the first layer may have a first side proximate the second layer and a second side opposite the second layer. Surface angles of microlenses may, for example, be measured from an axis normal to the second side of the first layer to a normal from a microlens surface. According to some such implementations, a difference of index of refraction between the first layer and the second layer may be relatively higher for lower-angled microlens surfaces, relative to a difference of index of refraction between the first layer and the second layer for higher-angled microlens surfaces. In some implementations, the lower-angled microlens surfaces have surface angles between zero and a threshold angle.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCD), organic light-emitting diode (OLED) displays, electrophoretic displays, and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a block diagram that includes example elements of a diffuser stack.

FIGS. 2A-2C show cross-sections through examples of diffuser stacks.

FIGS. 2D and 2E show examples of microlenses having different depths and radii of curvature.

FIG. 3 is a flow diagram that outlines an example of a process of fabricating a diffuser stack.

FIGS. 4A-4F are cross-sectional views that illustrate stages in an example of a process of fabricating a diffuser stack.

FIGS. 5A-5C illustrate stages in one example of a process of fabricating microlenses that include portions of substantially conical features.

FIGS. 6A and 6B show examples of microlenses having different shapes.

FIG. 7A shows examples of light rays reflecting from surfaces of microlenses.

FIG. 7B is a block diagram that includes example elements of a diffuser stack.

FIG. 8 shows examples of diffuser stack elements.

FIG. 9 shows an alternative example of a diffuser stack.

FIG. 10 is a flow diagram that outlines an example of a method for fabricating a diffuser stack.

FIG. 11 shows an example of an isometric view depicting two adjacent pixels in a series of pixels of an interferometric modulator (IMOD) display device.

FIG. 12 shows an example of a system block diagram illustrating an electronic device incorporating a 3×3 IMOD display.

FIGS. 13A-13E are cross-sectional illustrations of varying implementations of IMOD display elements.

FIG. 14 is a flow diagram illustrating a manufacturing process for an IMOD display or display element.

FIGS. 15A-15E are cross-sectional illustrations of various stages in a process of making an IMOD display or display element.

FIGS. 16A and 16B show examples of system block diagrams illustrating a display device that include a touch sensor as disclosed herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

It can be challenging to provide sufficient haze while minimizing reflection and unwanted artifacts. Moreover, currently available diffusers are generally formed of plastic or similar material. Such material may have a melting point that is too low to be compatible with other fabrication processes. Some implementations disclosed herein provide a diffuser that may be substantially transparent, with low amounts of back scatter and reflectivity, while providing a substantial haze value.

Some implementations disclosed herein include an apparatus including a first layer having a range of first layer indices of refraction. The range of first layer indices of refraction may include at least two indices of refraction. The apparatus may include a second layer proximate the first layer. The second layer may have a second index of refraction that is different from (e.g., lower than) the range of first layer indices of refraction. An interface between the first layer and the second layer may include an array of microlenses of substantially randomized sizes and locations. The microlenses may include sections of features that are substantially spherical, polygonal, conical, etc. According to some implementations, the first and second layers may be disposed between an array of display device pixels and a substantially transparent substrate, such as a glass substrate, a polymer substrate, etc.

The microlenses may include portions of the second layer that extend into the first layer. Each microlens may have an apex area of maximum extent into the first layer and lateral areas adjacent the apex area. A first layer index of refraction adjacent the apex area may be higher than a first layer index of refraction adjacent at least a portion of the lateral areas. A difference of index of refraction between the first layer and the second layer may be relatively higher for lower-angled microlens surfaces, relative to a difference of index of refraction between the first layer and the second layer for higher-angled microlens surfaces. The surface angles may, for example, be measured relative to a side of the first layer that is opposite the second layer. In some implementations, an anti-reflective layer may be disposed between the first layer and the second layer.

Particular implementations of the subject matter described in this disclosure can be implemented to realize one or more of the following potential advantages. Some implementations may provide a diffuser stack that directs low amounts of back scatter and reflection towards a user, while providing a substantial haze value. Forming the diffuser stack between a substantially transparent substrate (such as a display substrate, such as the substantially transparent substrate referenced above) and an array of pixels, instead of on the opposite side of the substantially transparent substrate, can provide improved optical properties, such as improved resolution. When the diffuser stack is positioned relatively farther from the pixels (e.g., by applying a conventional diffusing film, formed of a polymer, on the opposite side of a display substrate from the pixels), this configuration can reduce the resolution by blurring images formed by the pixels. However, when the diffuser stack is positioned closer to the pixels, the resolution remains higher and the diffuser stack can increase the viewing angle and reduce specular reflections.

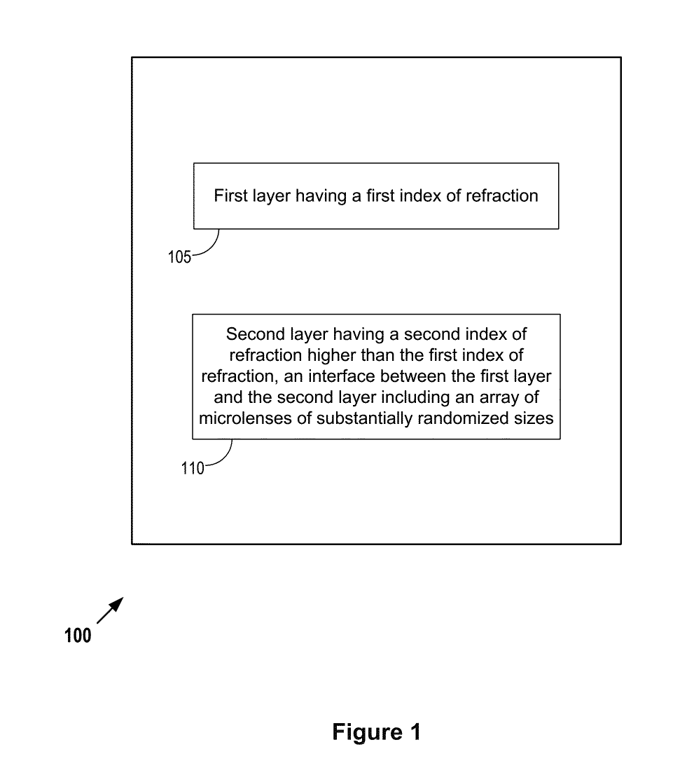

FIG. 1 is a block diagram that includes example elements of a diffuser stack. In this example, the diffuser stack 100 includes a first layer, the low-index layer 105, having a first index of refraction. The diffuser stack 100 also includes a second layer, the high-index layer 110 in this example, having a second index of refraction that is higher than the first index of refraction. However, in alternative implementations the second layer may have an index of refraction that is lower than the first index of refraction. The higher the difference between the first and second indices of refraction, the higher the haze of the diffuser stack. Hence, for high haze implementations, the second index of refraction will be larger than both the first index of refraction and the index of refraction of the substrate. In this example, an interface between the low-index layer 105 and the high-index layer 110 includes an array of microlenses of substantially randomized sizes.

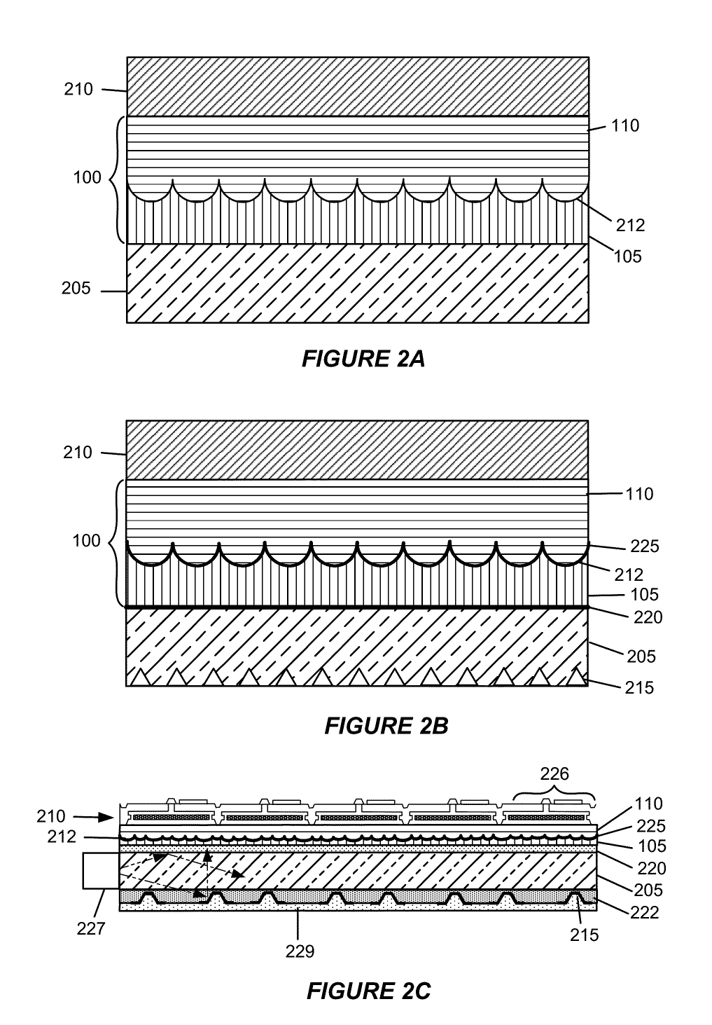

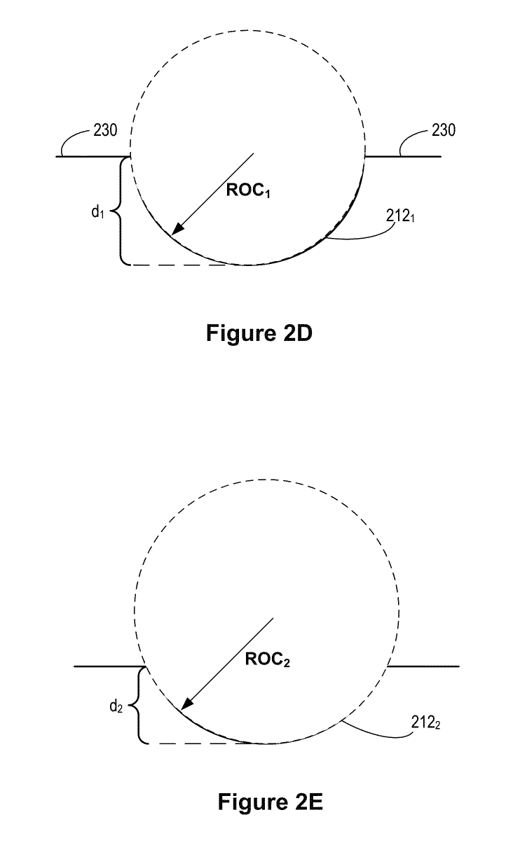

FIGS. 2A-2C show cross-sections through examples of diffuser stacks. In these examples, the diffuser stack 100 is disposed on a substrate 205, which is a glass substrate in these examples. In some implementations, the glass substrate may include a borosilicate glass, a soda lime glass, quartz, Pyrex™, or other suitable glass material. In alternative implementations, the substrate 205 may include suitable substantially transparent non-glass materials, such as polycarbonate, acrylic, polyethylene terephthalate (PET) or polyether ether ketone (PEEK).

Here, the diffuser stack 100 includes a low-index layer 105 and a high-index layer 110. In some implementations, the low-index layer 105 may include one or more materials having a relatively low index of refraction, such as SiO₂, SiOC (carbon-doped silicon oxide), spin-on glass (SOG), magnesium fluoride (MgF₂), polytetrafluoroethylene (PTFE), etc. In some implementations, the low-index layer 105 may have a thickness in the range of 1 to 10 microns, or 1 to 5 microns, or 1 to 3 microns.

The high-index layer 110 may include one or more materials that have a higher index of refraction than that of the low-index layer 105. For example, in some implementations the high-index layer 110 may include SiNₓOₓ. As known by those of ordinary skill in the art, the index of refraction of SiNₓOₓ may be controlled by varying the ratio of nitrogen to oxygen and/or by varying the pressure during a sputtering process. Accordingly, the index of refraction of a layer formed of SiNₓOₓ may vary substantially, e.g., from 1.7 or less to 2 or more. In alternative examples, the high-index layer 110 may include SiNₓ, ZrO₂, TiO₂ and/or Nb₂O₅. In some implementations, the high-index layer 110 may have a thickness in the range of 1 to 10 microns.

In the implementations shown in FIGS. 2A-2C, an interface between the low-index layer 105 and the high-index layer 110 includes an array of microlenses 212 having substantially randomized sizes. In these examples, the microlenses 212 include portions of substantially spherical features. However, in alternative examples, the microlenses 212 may include other shapes, such as portions of substantially polygonal or conical features.

As described in more detail below, in some implementations the array of microlenses 212 may be formed by etching features of substantially randomized sizes into the low-index layer 105 and filling in the features with the high-index layer 110. In some implementations, the etching process may include a dry etch process and/or a wet etch process. In some implementations, high-index layer 110 may be formed via deposition of a high refractive index passivation coating that substantially fills the concaves in the first layer. However, in alternative implementations, the array of microlenses 212 may be formed by etching features of substantially randomized sizes into a higher-index layer and filling in the features with a lower-index layer. Some implementations may include an anti-reflective layer between the higher-index layer and the lower-index layer, e.g., as described elsewhere herein.

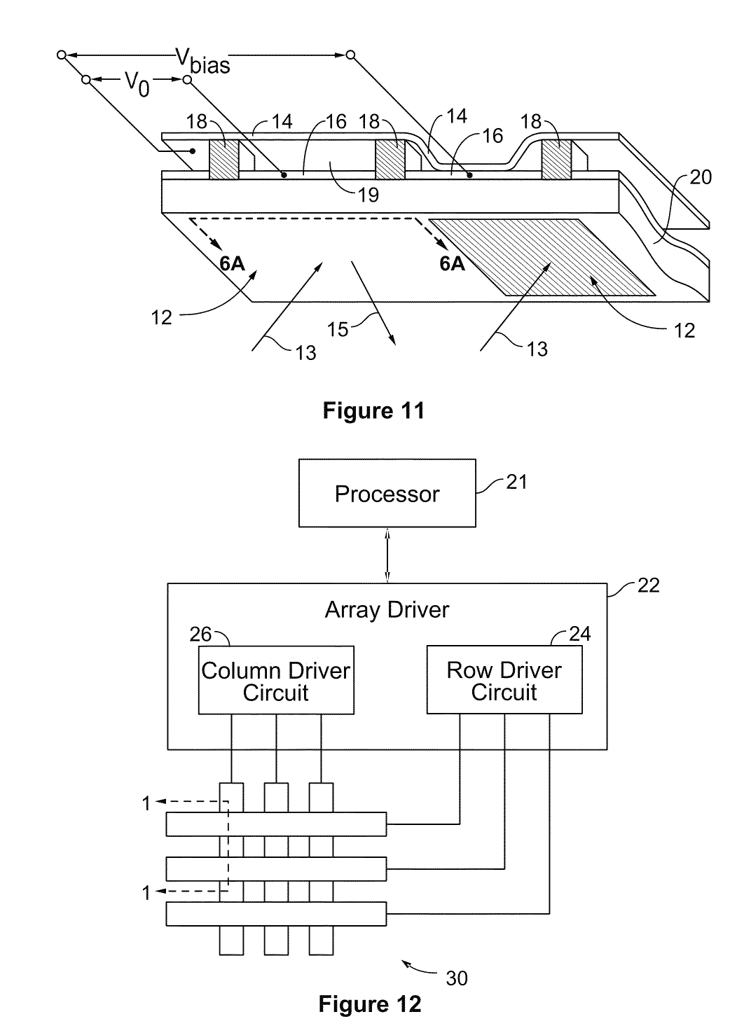

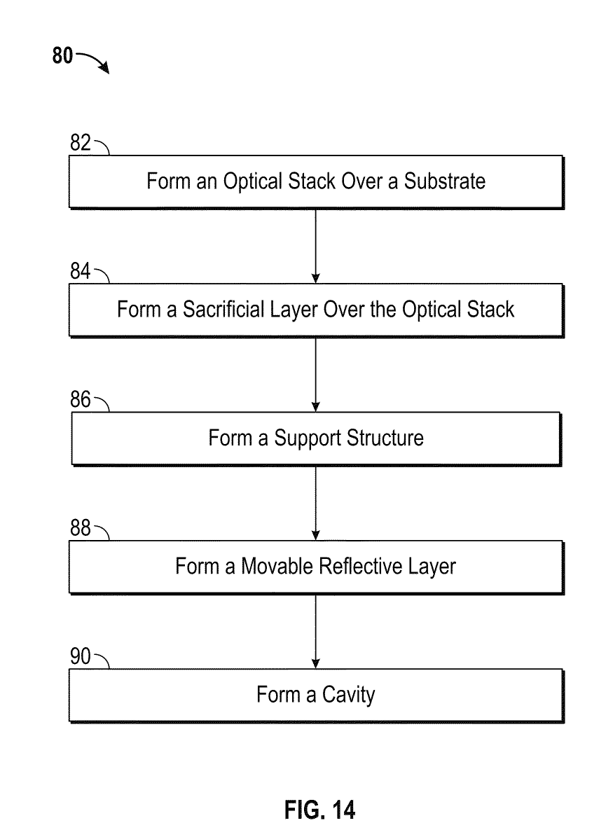

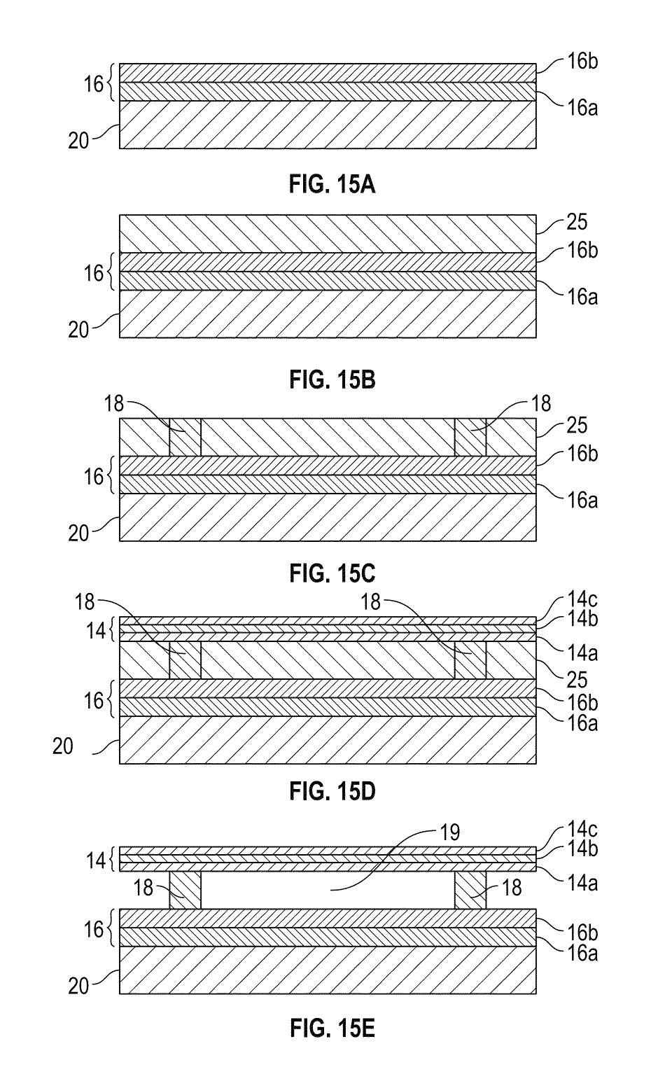

In the examples shown in FIGS. 2A-2C, an array of pixels 210 is disposed on the diffuser stack 100. As described in more detail below, in some implementations the array of pixels 210 may be fabricated on the diffuser stack 100. For example, the diffuser stack 100 may be fabricated on a substantially transparent stack that includes the substrate 205 and subsequently the array of pixels 210 may be fabricated on the diffuser stack 100. According to some implementations, the array of pixels 210 may be formed substantially as described below with reference to FIGS. 14 and 15A-15E, except that process 80 of FIG. 14 would include forming the diffuser stack 100 on the substrate 205, e.g., as described herein. As noted above, it can be advantageous to have the diffuser stack 100 disposed between a “display glass” such as the substrate 205 and the array of pixels 210. However, it would not be feasible to simply fabricate the array of pixels 210 on a typical diffusing layer. Such layers are generally made of a polymer with a relatively low melting point. The process of fabricating an array of pixels 210, such as an IMOD array, generally involves stages at which the temperature is substantially higher than this melting point. Therefore, if one were to attempt to fabricate an IMOD array on a typical diffusing layer, the diffusing layer would melt during the fabrication process. Some implementations may involve forming an array of IMOD pixels such as those described herein, e.g., those shown in FIGS. 11-13E and 15A-15E and described below.

In the examples shown in FIGS. 2B and 2C, the substrate 205 is capable of functioning as a light guide. In these implementations, a cladding layer 220 is disposed between the substrate 205 and the low-index layer 105. The cladding layer 220 may have a lower index of refraction than the low-index layer 105 and may allow the substrate 205 to function as a light guide. For example, if the low-index layer 105 is formed of SiO₂, the cladding layer 220 may be formed of spin-on glass, MgF₂ or SiOC. In some implementations, the cladding layer 220 can be about 1 micron thick or more and have an index of 1.38 or less. However, in some implementations, the refractive index of the low-index layer 105 may be sufficiently low that no additional cladding layer is necessary for the substrate 205 to function as a light guide.

FIG. 2C shows an example of a light source 227, which includes a light-emitting diode in this example, providing light to the substrate 205. In the examples shown in FIGS. 2B and 2C, the substrate 205 includes a plurality of light-extracting features 215 capable of extracting light from the light guide and providing at least a portion of the light to the array of pixels 210. It is understood that FIGS. 2B and 2C are schematic, and that the shape and density of light-extracting features 215 may vary according to the application and are only schematically shown relative to the size and density of the array of microlenses 212.

In the example shown in FIG. 2C, the light-extracting features 215 are capable of functioning as the electrodes of a touch panel. Here, a passivation layer 229 is formed over and within the light-extracting features 215. In this implementation, a cladding layer 222 is disposed between the passivation layer and the substrate 205. The cladding layer 222 may have a lower index of refraction than the substrate 205 and may, in combination with the cladding layer 220, allow the substrate 205 to function as a light guide.

Like the implementation shown in FIG. 2A, the examples of FIGS. 2B and 2C also include an array of microlenses 212. In the example shown in FIG. 2C, a single pixel 226 of the array of pixels 210 corresponds with multiple microlenses 212. In some implementations, a single pixel 226 of the array of pixels 210 may correspond with 10 or more microlenses 212. In some examples, a single pixel 226 of the array of pixels 210 may correspond with 25 or more microlenses 212.

In order to achieve a high haze value for the diffuser stack 100, it is desirable to minimize the light reflected in a specular direction (due to Fresnel reflections at flat dielectric-dielectric interfaces). Therefore, the microlenses 212 may be closely packed so that there is only a small amount of area not occupied by the microlenses 212 (and therefore flat), from which light may reflect in a specular fashion from the diffuser stack 100.

If the microlenses 212 are formed in a regular or periodic pattern, artifacts such as Moire effects and diffraction patterns may result. Accordingly, in various implementations the microlenses 212 may have sizes and/or distributions that are substantially random, in order to avoid such artifacts. In the examples shown in FIGS. 2A-2C, the microlenses have different sizes, each of which has a radius of curvature (ROC) and a depth. The ROC and/or the depth may be randomized.

FIGS. 2D and 2E show examples of microlenses having different depths and radii of curvature. Referring first to FIG. 2D, the microlens 212₁ has a radius of curvature ROC₁ and a depth d₁. FIG. 2D also provides examples of inter-microlens areas 230, from which light may reflect in a specular direction.

As compared to the microlens 212₁, the microlens 212₂ of FIG. 2E has a larger radius of curvature ROC₂. However, the microlens 212₂ has a relatively smaller depth d₂. Accordingly, a larger ROC does not necessarily correspond with a larger depth, although that could be the case.

In some implementations, the radii of curvature and/or the depths of the microlenses 212 may be selected from a random or quasi-random distribution. For example, the radii of curvature of the microlenses 212 may be selected from a Gaussian random distribution, with a specified mean and a specified standard deviation for the distribution. In various implementations, the mean of the radii of curvature in the random distribution can range from 2 to 10 microns, or 2 to 6 microns. In various implementations, the depth of the concaves into the surface of the first layer can range from 200 nm (0.2 microns) to 5 microns, or 500 nm (0.5 microns) to 2.5 microns. In some implementations, the depths are relatively similar with random or quasi-random distribution of the radii of curvature, while in other implementations, both the depth and the radii of curvature have a random or quasi-random distribution. Wet etching processes tend to produce concaves having somewhat uniform depth, while dry etching processes tend to produce more random depths.

The haze of the diffuser stack 100 may be controlled by varying the mean and standard deviation of the ROC and/or the difference between the refractive indices of the low-index layer 105 and the high-index layer 110. A higher difference between these refractive indices produces a higher haze value, which indicates increased diffusion. However, a higher difference between the refractive indices also causes more Fresnel reflection and back scatter at the interface between low-index layer 105 and the high-index layer 110, which may reduce the reflective contrast ratio of reflective pixels of the array of pixels 210. For example, a higher difference between the refractive indices may reduce the reflective contrast ratio of MS-IMOD pixels. For some reflective displays, diffusers have haze values of about 70-80%. For example, for reflective displays that include diffusers having haze values of about 70-80%, in some implementations the difference between the index of refraction of the first layer and the second layer is about 0.3 or more. However, for very low haze implementations, the difference between the index of refraction of the first layer and the second layer can be relatively small.

In the example shown in FIG. 2B, an anti-reflective layer 225 is disposed between the low-index layer 105 and the high-index layer 110. The anti-reflective layer 225 may reduce the amount of Fresnel reflection and back scatter of the microlenses 212. In this example, the anti-reflective layer 225 substantially conforms to the shape of concaves formed in the low-index layer 105. The anti-reflective layer 225 may, for example, be deposited after forming the microlenses 212 in the low-index layer 105 and before depositing the high-index layer 110.

In some implementations, the anti-reflective layer may include SiNₓOₓ. As noted above, the index of refraction of SiNₓOₓ may be controlled according to the ratio of nitrogen to oxygen and/or by varying the pressure during a sputtering process. Accordingly, the index of refraction of an anti-reflective layer 225 formed of SiNₓOₓ may be selected, as appropriate, according to the other materials used to form the diffuser stack 100. Some examples are provided below. However, in alternative implementations the anti-reflective layer 225 may include other materials, such as MgF₂.

In some examples, the anti-reflective layer 225 may be a quarter-wave index-matching layer. In some implementations, the thickness (dAR) and refractive index (nAR) of the anti-reflective layer 225 are chosen according to Equations (1) and (2), below:

n_{AR}(λ)=√n_{Film 1}(λ)*n_{Film 2}(λ) Equation (1)

$${d}_{AR} = \frac{λ}{4 \& {n}_{AR}} \qquad Equation ( 2 )$$

In Equation (1), n_{Film 1} represents the index of refraction of a first layer (e.g., the low-index layer 105) and n_{Film 2} represents the index of refraction of a second layer (e.g., the high-index layer 110). If the anti-reflective layer 225 is thin, it may adopt the shape of the concaves in the low-index layer 105. The shape of the high-index layer 110 may conform to the shape of the concaves in the first layer. Therefore, including an anti-reflective layer 225 may not substantially change the haze of the diffusion layer, but may nonetheless reduce the amount of Fresnel reflection and back scatter of the microlenses 212.

Table 1 shows some examples of simulation results of optical properties for diffuser stacks with and without anti-reflective layers 225:

TABLE 1

| | Standard | | | | | | | | | |
|---|---|---|---|---|---|---|---|---|---|---|
| Mean | Deviation | Lens | | | | | | Total | | |
| ROC | of ROC | Depth | | | | | d_{AR} | Forward | Back | |
| (um) | (um) | (um) | N_{Layer 1} | N_{Layer 2} | | n_{AR} | (nm) | Transmission % | Scatter % | Haze % |
| 5 | 2 | 2 | 1.46 | 1.71 | W/O AR | NA | NA | 98.86 | 0.31 | 81.79 |
| | | | | | W/AR | 1.58 | 94 | 99.64 | 0.042 | 81.79 |
| 6 | 3 | 1 | 1.4 | 2.0 | W/O AR | NA | NA | 96.24 | 2.08 | 78.78 |
| | | | | | W/AR | 1.68 | 89 | 99.48 | 0.18 | 78.43 |

One diffuser stack 100 represented in Table 1 includes a low-index layer 105 of SiO₂, with a refractive index of 1.46, and a second layer of SiNₓOₓ with a refractive index of 1.71. The other diffuser stack represented in Table 1 includes a low-index layer 105 of SOG, having a refractive index of 1.4, and a second layer of SiNₓOₓ with a refractive index of 2. In the latter case, the low-index layer 105 also may function as a cladding layer for allowing the substrate 205 to function as a light guide. Alternatively, or additionally, the diffuser stack 100 also may include a separate cladding layer 220 between the low-index layer 105 and the substrate 205 (e.g., as shown in FIG. 2B), to ensure sufficient internal reflection for the substrate 205 to function as a light guide.

In the examples shown in Table 1, adding the anti-reflective layer 225 can reduce back scatter by approximately 10% and can improve forward transmission. However, adding the anti-reflective layer 225 may not substantially affect the haze value.

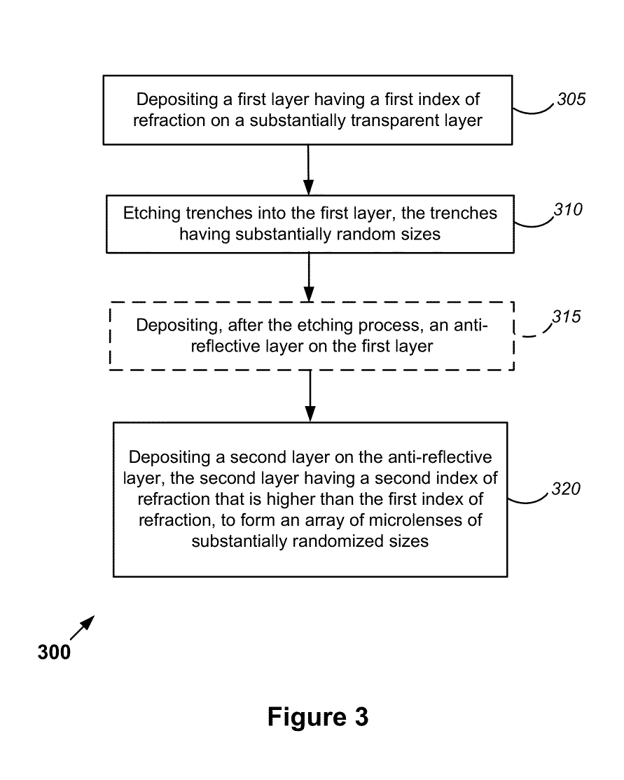

FIG. 3 is a flow diagram that outlines an example of a process of fabricating a diffuser stack. The operations of method 300 are not necessarily performed in the order shown in FIG. 3. Moreover, method 300 may involve more or fewer blocks than are shown in FIG. 3. In this example, the method 300 begins with block 305, which involves depositing a first layer having a first index of refraction on a substantially transparent layer. For example, block 305 may involve a physical vapor deposition (PVD) process, a chemical vapor deposition (CVD) process, or another such process for depositing thin layers. In some implementations, the first index of refraction is lower than an index of refraction of the substrate. In some implementations, the substantially transparent layer may include a cladding layer and a substantially transparent substrate. The cladding layer may have an index of refraction that is lower than the first index of refraction.

Here, block 310 involves etching concaves into the first layer. In this example, the concaves have substantially random sizes. For example, the concaves may have substantially random radii of curvature and/or depths. In this implementation, optional block 315 involves depositing, after the etching process, an anti-reflective layer on the first layer. Block 315 may, for example, involve a PVD process, a CVD process, etc. In some implementations, depositing the anti-reflective layer includes conformally depositing the anti-reflective layer so that it conforms to the shape of the etched first layer. Block 320 may involve a PVD process, a CVD process, etc. Here, block 320 involves depositing a second layer on the first layer, or the anti-reflective layer, to form an array of microlenses of substantially randomized sizes. In this example, the second layer has a second index of refraction that is higher than the first index of refraction. In some implementations, the deposited second layer planarizes the topography of the first layer or the stack of the first layer and the anti-reflective layer.

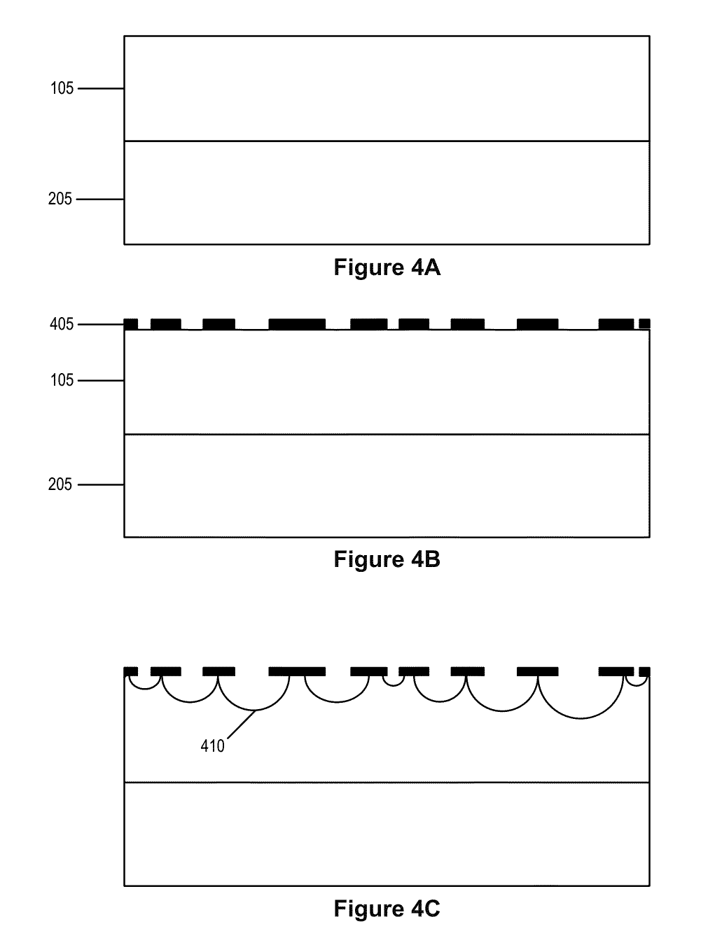

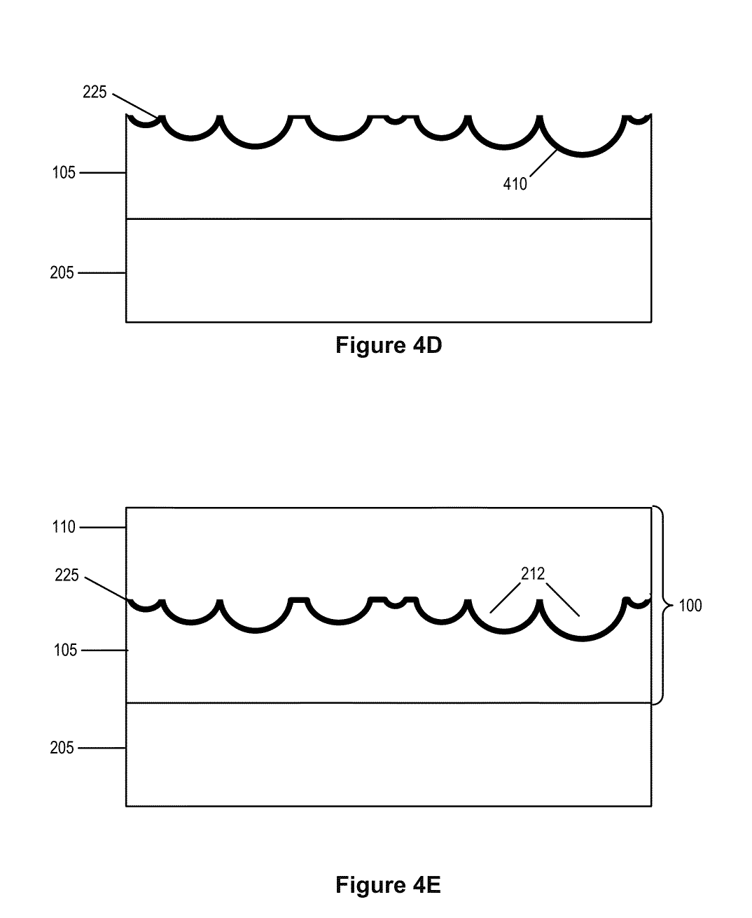

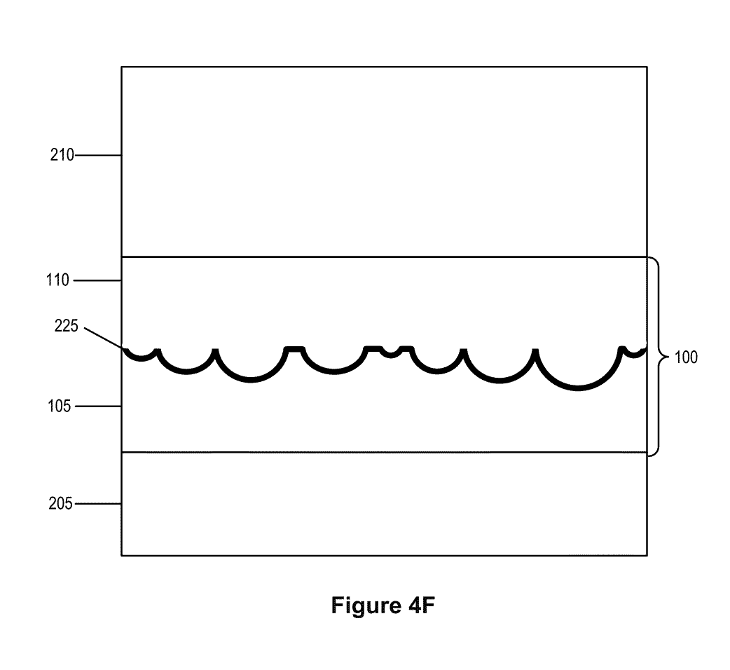

FIGS. 4A-4F are cross-sectional views that illustrate stages in an example of a process of fabricating a diffuser stack. FIG. 4A illustrates an example of a low-index layer 105 deposited on a substrate 205. The configuration shown in FIG. 4A may result, for example, after block 305 of FIG. 3.

At the stage shown in FIG. 4B, photoresist material 405 has been deposited on the low-index layer 105 and patterned. The particular pattern of photoresist material 405 shown in FIG. 4B is merely an example. In alternative implementations, the photoresist material 405 may processed according to a grayscale lithography process. Grayscale lithography, often used with dry etch techniques, allows greater control of the curvature of the walls of the concaves formed into the substrate. Grayscale techniques allow forming concaves onto the photoresist surface, and the surface formed on the photoresist can then be transferred to the substrate using the etchant.

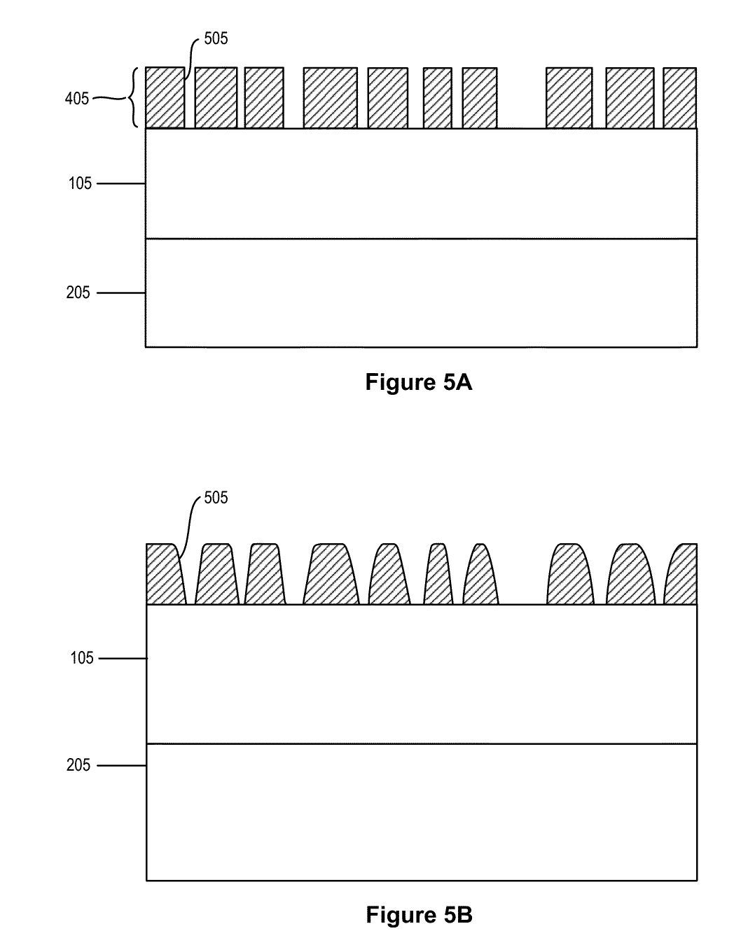

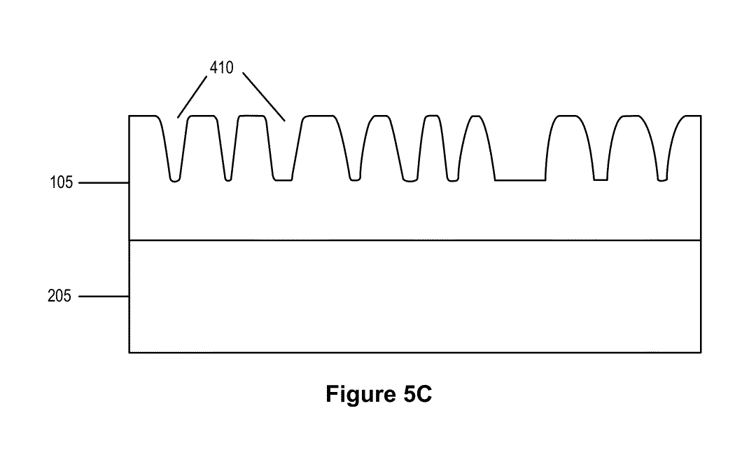

At the stage shown in FIG. 4C, concaves have been etched into the first layer. Accordingly, FIG. 4C corresponds with the completion of a process such as that of block 310 of FIG. 3. In this example, the concaves have substantially random sizes and have been formed by a wet etch process. However, in other implementations, the process could include a dry etch process. Some such examples are described below with reference to FIGS. 5A and 5B.

In this implementation, the photoresist material 405 has been patterned such that the radii of curvature and/or the depths of the concaves 410 have a random or quasi-random distribution. For example, the radii of curvature of the concaves 410 may be selected from a Gaussian random distribution, with a specified mean and a specified standard deviation for the distribution. In some examples, the arrangement of the concaves 410 may be selected according to a computer simulation based, at least in part, on the principles of molecular dynamics. For example, the layout of a mask used to pattern the photoresist material 405 may be selected according to a computer simulation based, at least in part, on molecular dynamics.

At the stage shown in FIG. 4D, the photoresist material 405 has been removed and an anti-reflective layer 225 has been deposited on the low-index layer 105. In this implementation, the anti-reflective layer 225 is substantially conformal with the shapes of the concaves 410.

In the example shown in FIG. 4E, a high-index layer 110 has been deposited on the anti-reflective layer 225. Portions of the high-index layer 110 have been deposited in the concaves 410, on the anti-reflective layer 225, to form microlenses 212. Accordingly, the resulting diffuser stack 100 includes an array of microlenses 212 having substantially random sizes. In these examples, the microlenses 212 include portions of substantially spherical features. However, in alternative examples, the microlenses 212 may include other shapes, such as portions of substantially polygonal or conical features.

FIG. 4F shows an example of an array of pixels 210 proximate the diffuser stack 100. In this example, the array of pixels 210 has been fabricated on the diffuser stack 100.

Some examples of fabricating an array of pixels 210 are provided below, especially in FIG. 14. In FIG. 14, the “substrate” referenced in block 82 may include substrate 205, low-index layer 105, and high-index layer 110 since the array pixels 210 are formed over both the substrate 205 and the diffuser stack 100.

FIGS. 5A-5C illustrate stages in one example of a process of fabricating microlenses that include portions of substantially conical features. In this example, at the stage depicted in FIG. 5A the photoresist material 405 has been deposited on the low-index layer 105 and patterned. However, in this example, the concaves 410 are formed by a dry etch process. At the stage depicted in FIG. 5A, the sidewalls 505 are substantially vertical in this example.

FIG. 5B shows an example of the stack of FIG. 5A after a thermal reflow process. At the stage depicted in FIG. 5B, the reflow process has changed the shape of the sidewalls 505. In alternative implementations, the reflow process may produce other shapes for the sidewalls 505, such as curved shapes.

FIG. 5C shows an example of concaves formed after etching through the photoresist material 405 and into portions of the low-index layer 105 shown in FIG. 5B. FIG. 5C may, for example, depict concaves 410 resulting from a dry etching process which has transferred the topography of the photoresist material 405 of FIG. 5B into the low-index layer 105 of FIG. 5C. In this example, the resulting concaves 410 are substantially conical. Accordingly, if the concaves 410 were filled with a high-index layer 110, the resulting microlenses 212 would also be substantially conical.

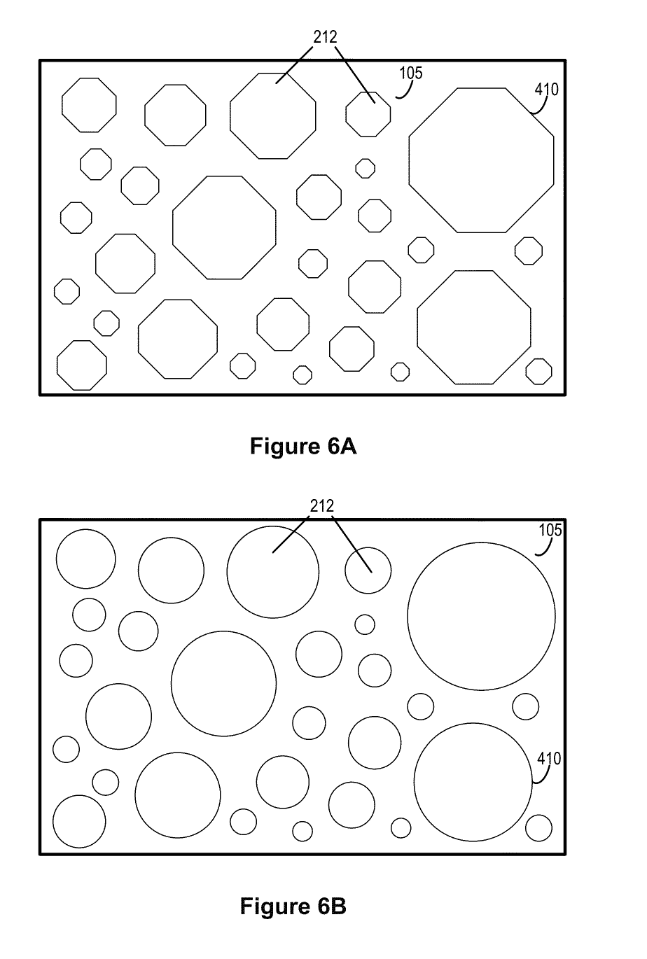

FIGS. 6A and 6B show examples of microlenses having different shapes. In the example shown in FIG. 6A, the microlenses 212 have been formed in octagonal concaves 410 after a dry etch process. Accordingly, the microlenses 212 are octagonal in cross-section. In the example shown in FIG. 6B, the concaves 410 are substantially circular in cross-section and have been formed by a wet etch process. Accordingly, the resulting microlenses 212 are substantially circular in cross-section.

As noted above, the larger the change in refractive index at the surfaces of the microlenses 212, the larger the ray refraction and consequently the higher haze of the diffuser stack 100. (Such a change in refractive index may sometimes be referred to herein as a “difference of index of refraction” or as a refractive index contrast.) In addition, the smaller the radius of curvature of the microlenses 212, the higher the haze value of the diffuser stack 100.

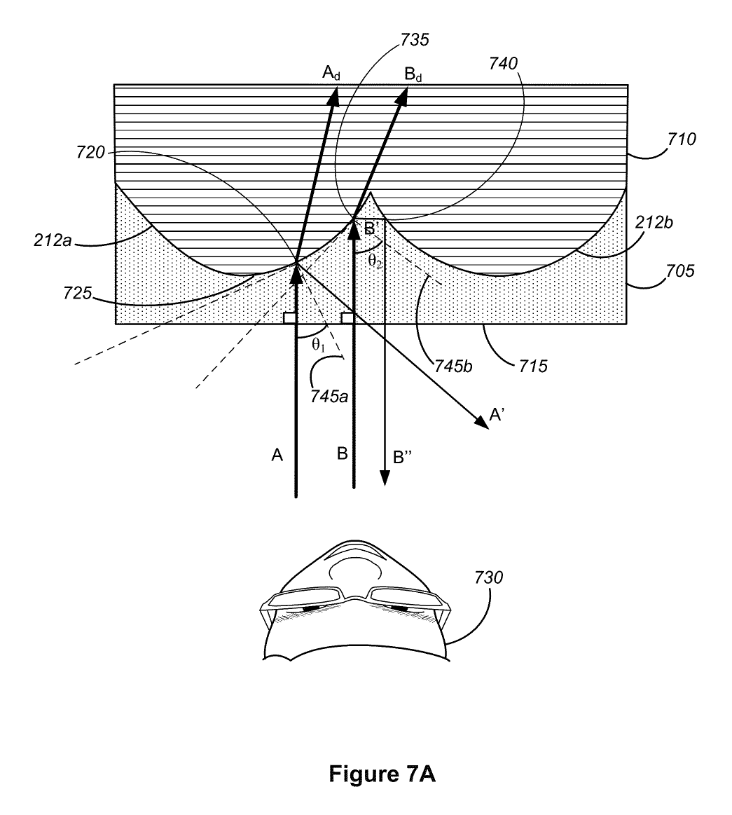

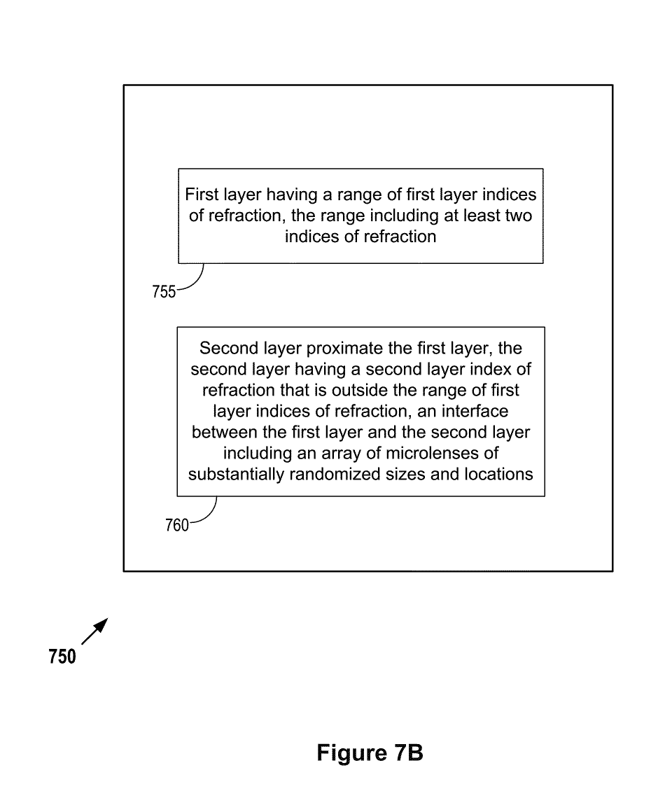

However, a large difference of index of refraction and a larger curvature tend to cause more back reflection, resulting in a lower display contrast ratio. FIG. 7A shows examples microlens diffuser. Incident rays A and B are refracted and reflected. In this example, light rays A and B are shown refracting and reflecting from surfaces of adjacent microlenses 212a and 212b. The refracted rays are denoted by A_{d} and B_{d} respectively, and the reflected rays are denoted by A′ and B′ (and B″) respectively. In this example, the surface angles of microlenses 212a and 212b are measured relative to the normal of the microlens surface. In this example, the incident light rays A and B are normal to the side 715 of the first layer 705. Accordingly, the surface angle θ₁ is measured from a normal to the side 715 to the normal 745a of the microlens surface 725. Likewise, the surface angle θ₂ is measured from a normal to the side 715 to the normal 745b of the microlens surface 725. Here, the light ray A reflects from a position 720 of microlens 212a, which is a relatively lower-angle surface near the apex 725 of the microlens 212a, having a surface angle of θ₁ . Accordingly, the reflected light ray A′ is directed away from the viewer 730.

However, the light ray B reflects from a position 735 of microlens 212a, which is in a relatively higher-angle lateral area farther from the apex 725 of the microlens 212a, having a surface angle of θ₂. In this example, the reflection B′ from the light ray B is directed towards position 740 in a corresponding higher-angle lateral area of the microlens 212b. A back-reflected portion B″ of the reflected light ray B′ reflects from the surface position 740 towards the viewer 730.

Various implementations disclosed herein include diffuser stacks that can provide a substantially high haze value, while potentially reducing the amount of back reflection. For implementations in which such diffuser stacks are incorporated into a display device, such implementations may provide a relatively higher display contrast ratio due to reduced back reflection.

FIG. 7B is a block diagram that includes example elements of a diffuser stack. In this implementation, the apparatus 750 includes a first layer 755 having a range of first layer indices of refraction. In this example, the range of first layer indices of refraction includes at least two indices of refraction. In the implementation shown in FIG. 7B, the apparatus 750 includes a second layer 760 proximate the first layer. The second layer 760 may have an index of refraction (or a range of indices of refraction) outside the range of first layer indices of refraction. For example, the second layer 760 may have a second layer index of refraction that is lower than the range of first layer indices of refraction. In alternative examples, the second layer 760 may have a second layer index of refraction that is higher than the range of first layer indices of refraction. An interface between the first layer 755 and the second layer 760 may include an array of microlenses of substantially randomized sizes and locations.

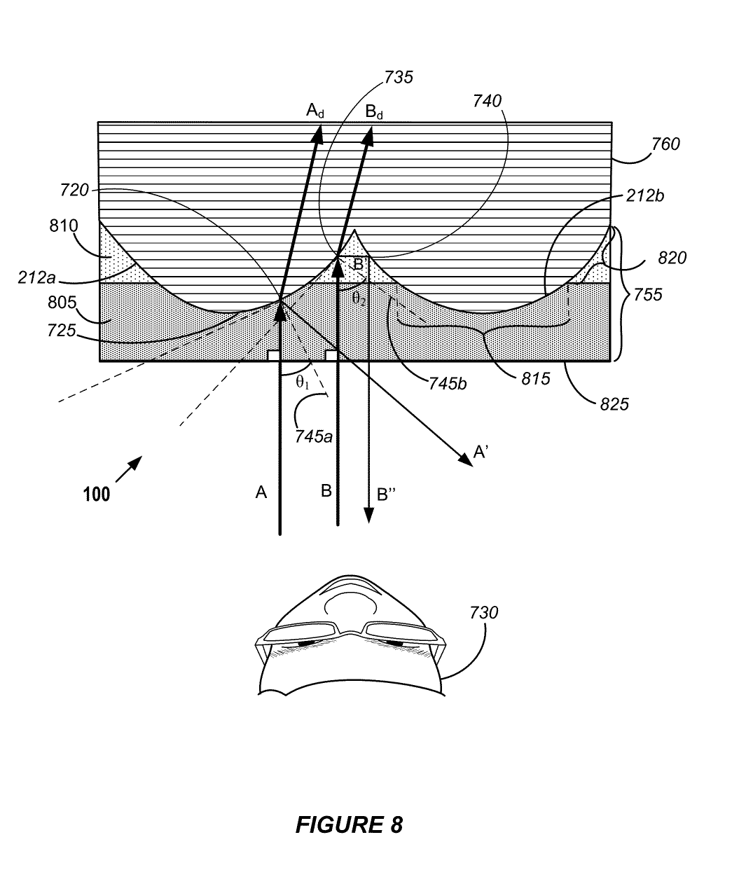

FIG. 8 shows examples of diffuser stack elements. In this implementation, the diffuser stack 100 includes examples of the first layer 755 and the second layer 760 shown in FIG. 7B. Accordingly, the first layer 755 has a range of first layer indices of refraction. In this example, the range of first layer indices of refraction includes two indices of refraction: here, the sub-layer 805 has a first sub-layer index of refraction and the sub-layer 810 has a second sub-layer index of refraction. According to some examples, the first sub-layer index of refraction is relatively higher than the second sub-layer index of refraction.

For example, in some implementations the first layer 755 may include SiOₓN_{y}. As known by those of ordinary skill in the art, the index of refraction of SiOₓN_{y} may be controlled by varying the ratio of nitrogen to oxygen and/or by varying the pressure during a sputtering process. Accordingly, the index of refraction of a layer formed of SiOₓN_{y} may vary substantially, e.g., from 1.7 or less to 2 or more. Accordingly, in some implementations, both the first sub-layer and the second sub-layer may be formed of SiOₓN_{y} , but yet the first sub-layer index of refraction and the second sub-layer index of refraction may be different. In alternative examples, the first layer 755 may include other materials, such as SiNₓ, ZrO₂, TiO₂ and/or Nb₂O₅.

In the implementation shown in FIG. 8, the apparatus 750 includes a second layer 760 proximate the first layer 755. In some implementations, the second layer 760 may include one or more materials having a relatively low index of refraction, such as SiO₂, SiOC (carbon-doped silicon oxide), spin-on glass (SOG), magnesium fluoride (MgF₂), polytetrafluoroethylene (PTFE), etc. In this example, the second layer 760 has a second layer index of refraction that is lower than the range of first layer indices of refraction. Accordingly, in this example the second layer index of refraction is less than the first sub-layer index of refraction or the second sub-layer index of refraction. In alternative implementations, the second layer index of refraction may be greater than the first sub-layer index of refraction or the second sub-layer index of refraction. In some implementations, the second layer 760 may have a range of second layer indices of refraction.

In this example, an interface between the first layer 755 and the second layer 760 includes an array of microlenses 212 of substantially randomized sizes and locations, two of which (microlenses 212a and 212b) are shown in FIG. 8. In some examples, the microlenses 212 may include sections of features that are substantially spherical, polygonal, conical, etc. The microlenses 212 may include portions of the second layer 760 that fill substantially spherical, polygonal or conical features in the first layer.

Here, the microlenses 212a and 212b include portions of the second layer 760 that extend into the first layer 755. In this example, each of the microlenses 212a and 212b includes an apex area 815 of maximum extent into the first layer 755 and lateral areas 820 adjacent each of the apex areas 815. In this implementation, the index of refraction of the first layer 755 adjacent the apex areas 815 is higher than the index of refraction of the first layer 755 adjacent at least a portion of the lateral areas 820: here, the apex areas 815 are adjacent the sub-layer 805, which has a first sub-layer index of refraction that is relatively higher than that of the sub-layer 810, which is adjacent the lateral areas 820.

In the example shown in FIG. 8, it may be seen that the surfaces of microlenses 212a and 212b in the apex areas 815, such as the position 720 from which the light ray A is reflecting, are relatively lower-angled microlens surfaces than the surfaces of microlenses 212a and 212b in the lateral areas 820, such as the position 735 from which the light ray B is reflecting. The surface angles may, for example, be measured relative to the normal of the microlens surface 725, such as the surface angles θ₁ and θ₂ shown in FIG. 8. In this example, the incident light rays A and B are normal to the side 825 of the first layer 755. Accordingly, the surface angle θ₁ is measured from a normal to the side 825 to the normal 745a of the microlens surface 725. Likewise, the surface angle θ₂ is measured from a normal to the side 825 to the normal 745b of the microlens surface 725.

Accordingly, in this example, a difference of index of refraction between the first layer 755 and the second layer 760 is relatively higher for lower-angled microlens surfaces, relative to a difference of index of refraction between the first layer 755 and the second layer 760 for higher-angled microlens surfaces. In some implementations, “lower-angled” and/or “higher-angled” microlens surfaces may have their angle ranges quantified in some manner. For example, in some implementations “lower-angled” microlens surfaces may have surface angles between zero (e.g., at the apex 725 of a microlens 212) and a threshold angle.

In some examples, the “higher-angled” microlens surfaces may be less than or equal to a maximum angle. In some such implementations, the maximum angle may be in the range of 40 to 50 degrees, e.g., 45 degrees.

Areas of the diffuser layer 100 that provide a higher difference of index of refraction at microlens surfaces (such as the apex areas 815) will provide a higher haze value to the refracted light, such as light ray A_{d.} However, the amount of light that is back-scattered towards the viewer 730 from microlens surfaces having a higher difference of index of refraction may be reduced because the light may not be reflected directly back at the viewer 730: in the example shown in FIG. 8, the reflected light ray A′ is directed away from the viewer 730. Moreover, the amount of light that is back-scattered towards the viewer 730 from microlens surfaces having a higher difference of index of refraction may be reduced because the amount of Fresnel reflection is relatively small, because the reflection angle is relatively small.

Areas of the diffuser layer 100 that provide a lower difference of index of refraction at microlens surfaces (such as the lateral areas 820) will provide a lower haze value to the refracted light, such as light ray B_{d.} Moreover, much of this light tends to be reflected directly back at the viewer, as in the example of back-reflected portion B″. However, the amount of light that is back-scattered from toward the viewer may be reduced because of lower reflectivity resulting from the relatively smaller difference in refractive index in the lateral areas 820.

In some implementations, an anti-reflective layer (such as a conformal anti-reflective layer) may be disposed between the first layer 755 and the second layer 760. One example is the anti-reflective layer 225 shown in FIGS. 4D-4F and described above.

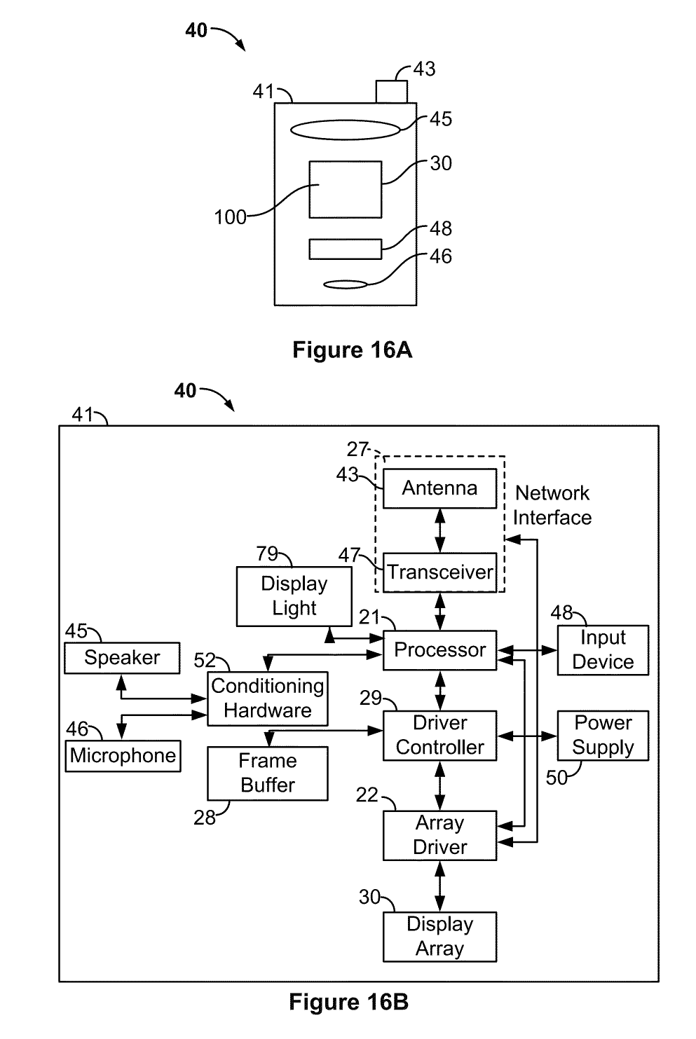

According to some implementations, the diffuser stack 100 may be disposed between an array of display device pixels and a substantially transparent substrate, such as a glass substrate, a polymer substrate, etc. For example, some implementations may include an array of display device pixels proximate the second layer 760 and a substantially transparent substrate proximate the first layer 755. The substrates 205 and the array of pixels 210 shown in FIGS. 2A-2C are examples of such a substantially transparent substrate and such an array of display device pixels. The array of display device pixels may, for example, include IMOD pixels such as those shown in FIGS. 11, 13A-3E and 15A-15E, and described below. The array of display device pixels may, for example, form a display 30 such as that shown in FIGS. 12, 16A and 16B, and described below.

In some implementations, the substantially transparent substrate may be capable of functioning as a light guide. According to some examples, the light guide may include a plurality of light-extracting features (such as the light-extracting features 215 of FIGS. 2B and 2C) capable of extracting light from the light guide and capable of providing at least a portion of the extracted light to the array of pixels.

As described above, some implementations may include a cladding layer between the substantially transparent substrate and the first layer 755. One such example is the cladding layer 220 shown in FIG. 2B. In some implementations, the cladding layer may have a cladding layer index of refraction that is lower than the range of first layer indices of refraction.

FIG. 9 shows an alternative example of a diffuser stack. In some implementations, as here, the diffuser stack 100 includes a first layer 755 that has a range of first layer indices of refraction that includes more than two indices of refraction. In this example, the first layer 755 has a graded index of refraction. In some implementations, the graded index of refraction may be realized by depositing multiple discrete SiON layers of gradually reduced refractive index. In this example, the incident light rays A and B are normal to the side 825 of the first layer 755. Therefore, the surface angle θ₁ is measured from a normal to the side 825 to the normal 745a of the microlens surface 725. Similarly, the surface angle θ₂ is measured from a normal to the side 825 to the normal 745b of the microlens surface 725.

In this implementation, the back reflection from the higher-angle light rays (such as the light ray B) will be reduced because such light rays are incident on a surface having a lower difference in refractive index between the first layer 755 and the second layer 760. The reflections of the lower-angle light rays (such as the light ray A) will be scattered with a relatively higher haze value because they are incident on a surface having a higher difference in refractive index between the first layer 755 and the second layer 760, yet such reflections may not produce an unacceptable amount of back scattering. Such implementations may provide increased diffuser haze while minimizing back scattering.

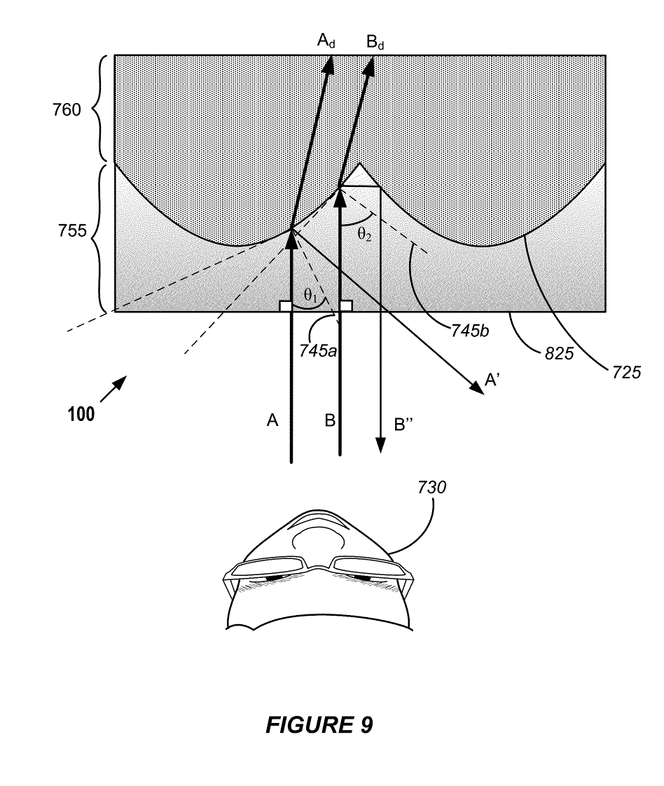

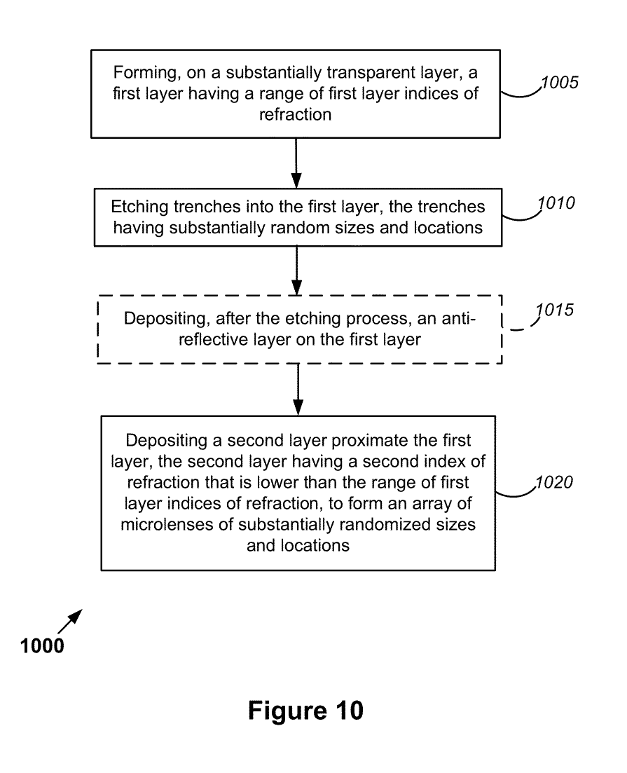

FIG. 10 is a flow diagram that outlines an example of a method for fabricating a diffuser stack. The operations of method 1000 are not necessarily performed in the order shown in FIG. 10. Moreover, method 1000 may involve more or fewer blocks than are shown in FIG. 10.

In this example, the method 1000 begins with block 1005, which involves forming, on a substantially transparent layer, a first layer having a range of first layer indices of refraction. The first layer may, for example, be an example of the first layer 755 described above. In this example, the range includes at least two indices of refraction. For example, block 1005 may involve a physical vapor deposition (PVD) process, a chemical vapor deposition (CVD) process, or another such process for depositing thin layers. In some implementations, block 1005 may involve depositing multiple layers, each having a different index of refraction. In some examples, the first layer may have a graded index of refraction. For example, block 1005 may involve forming the graded index of refraction by depositing multiple discrete SiON layers of gradually reduced refractive index.

In some implementations, the substantially transparent layer may include a cladding layer and a substantially transparent substrate. The cladding layer may have an index of refraction that is lower than the range of first layer indices of refraction and the index of refraction of the transparent substrate.

Here, block 1010 involves etching trenches, such as concaves, into the first layer. In this example, the trenches have substantially random sizes and locations. For example, the trenches may be concaves that have substantially random radii of curvature and/or depths, such as those shown in FIGS. 4C-4F.

In this implementation, optional block 1015 involves depositing, after the etching process, an anti-reflective layer on the first layer. Block 1015 may, for example, involve a PVD process, a CVD process, etc. In some implementations, depositing the anti-reflective layer may involve conformally depositing the anti-reflective layer so that it conforms to the shape of the etched first layer.

Here, block 1020 involves depositing a second layer proximate the first layer (e.g., on the first layer or on the anti-reflective layer), to form an array of microlenses of substantially randomized sizes and locations. The second layer may, for example, be an example of the second layer 760 described above. In this example, the second layer has a second layer index of refraction that is lower than the range of first layer indices of refraction. Block 1020 may involve a PVD process, a CVD process, and spin or slid coating, etc. In some implementations, the deposited second layer planarizes the topography of the first layer or the stack of the first layer and the anti-reflective layer.

The microlenses may include portions of the second layer that extend into the first layer, e.g., as shown in FIGS. 8 and 9. Each microlens may have an apex area of maximum extent into the first layer and lateral areas adjacent the apex area, such as the apex areas 815 and lateral areas 820 shown in FIG. 8.

In some implementations, method 1000 may be implemented, at least in part, via one or more non-transitory media having software stored thereon. The software may include instructions for controlling one or more device (such as one or more devices of a semiconductor fabrication facility) to form a diffuser stack.

FIG. 11 shows an example of an isometric view depicting two adjacent pixels in a series of pixels of an IMOD display device. The IMOD display device includes one or more interferometric MEMS display elements. In these devices, the pixels of the MEMS display elements can be positioned in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be capable of reflecting predominantly at particular wavelengths allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 11 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 11, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be adapted to be viewed from the opposite side of a substrate as the display elements 12 of FIG. 11 and may be supported by a non-transparent substrate.

In the example shown in FIG. 11, the optical stack 16 is adjacent to the transparent substrate 20. However, some implementations may include a diffuser stack, such as the diffuser stack 100 disclosed herein, between the optical stack 16 and the transparent substrate 20.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 11, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 11. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 12 is a system block diagram illustrating an electronic device incorporating an IMOD-based display including a three element by three element array of IMOD display elements. The electronic device includes a processor 21 that may be capable of executing one or more software modules. In addition to executing an operating system, the processor 21 may be capable of executing one or more software applications, including a web browser, a telephone application, an email program, or any other software application.

The processor 21 can be capable of communicating with an array driver 22. The array driver 22 can include a row driver circuit 24 and a column driver circuit 26 that provide signals to, for example a display array or panel 30. The cross section of the IMOD display device illustrated in FIG. 11 is shown by the lines 1-1 in FIG. 9. Although FIG. 12 illustrates a 3×3 array of IMOD display elements for the sake of clarity, the display array 30 may contain a very large number of IMOD display elements, and may have a different number of IMOD display elements in rows than in columns, and vice versa.

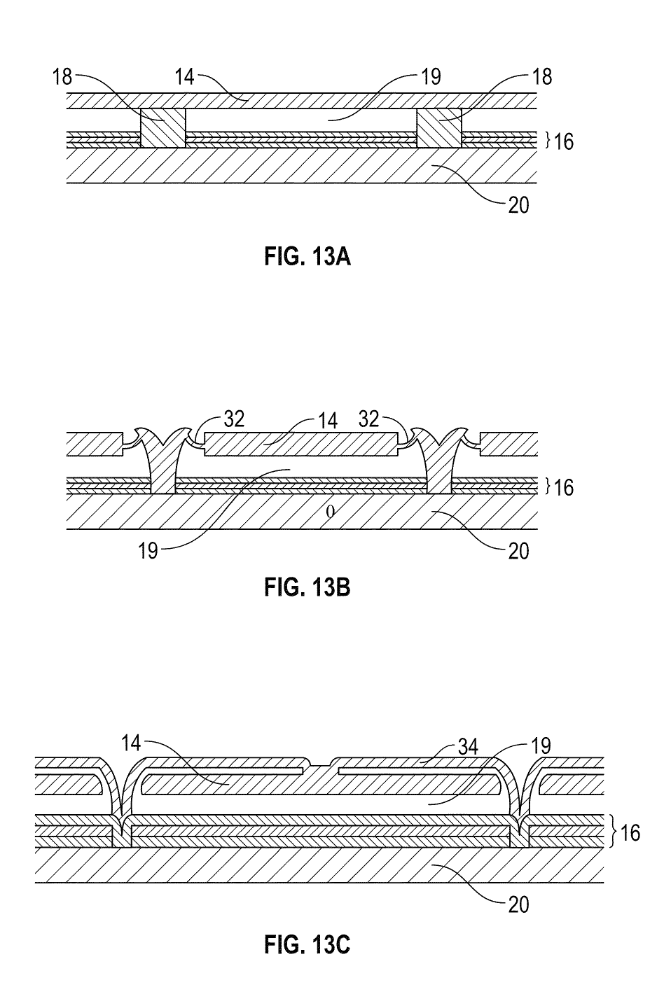

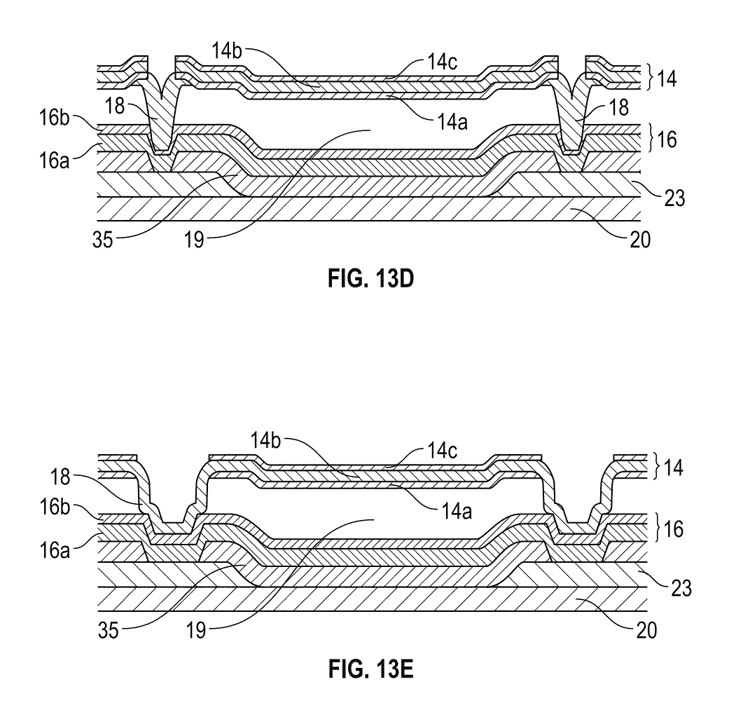

The details of the structure of IMOD displays and display elements may vary widely. FIGS. 13A-13E are cross-sectional illustrations of varying implementations of IMOD display elements. FIG. 13A is a cross-sectional illustration of an IMOD display element, where a strip of metal material is deposited on supports 18 extending generally orthogonally from the substrate 20 forming the movable reflective layer 14. In the examples shown in FIGS. 13A-13E, the optical stack 16 is adjacent to the transparent substrate 20. However, some implementations may include a diffuser stack, such as the diffuser stack 100 disclosed herein, between the optical stack 16 and the transparent substrate 20.

In FIG. 13B, the movable reflective layer 14 of each IMOD display element is generally square or rectangular in shape and attached to supports at or near the corners, on tethers 32. In FIG. 13C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 13C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 13D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 13D, some implementations also can include a black mask structure 23, or dark layer layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 13E is another cross-sectional illustration of an IMOD display element, where the movable reflective layer 14 is self-supporting. While FIG. 13D illustrates support posts 18 that are structurally and/or materially distinct from the movable reflective layer 14, the implementation of FIG. 13E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 13E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 13A-13E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 13C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

FIG. 14 is a flow diagram illustrating a manufacturing process 80 for an IMOD display or display element. FIGS. 15A-15E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 14.

In this example, the process 80 begins at block 82 with the formation of the optical stack 16 over the substrate 20. However, in alternative examples, the process 80 may involve forming a diffuser stack, such as the diffuser stack 100 disclosed herein, between the optical stack 16 and the transparent substrate 20. In some such examples, the diffuser stack 100 may be formed as disclosed elsewhere herein, e.g., as described above with reference to FIGS. 3-6B and 10.

FIG. 15A illustrates such an optical stack 16 formed over the substrate 20. The substrate 20 may be a transparent substrate such as glass or plastic such as the materials discussed above with respect to FIG. 11. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 15A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 15A-15E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 15B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 15E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 15C, the aperture formed in the sacrificial layer 25 can extend through the sacrificial layer 25, but not through the optical stack 16. For example, FIG. 15E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 15C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 15D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 15D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

FIGS. 16A and 16B show examples of system block diagrams illustrating a display device that includes a diffuser stack as disclosed herein. The display device 40 can be, for example, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, a diffuser stack 100, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as disclosed herein. The display 30 also can include a flat-panel display, such as plasma, EL, OLED, STN LCD, or TFT LCD, or a non-flat-panel display, such as a CRT or other tube device. In addition, the display 30 can include an IMOD-based display, as disclosed herein.

The components of the display device 40 are schematically illustrated in FIG. 16B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 16B, can be capable of functioning as a memory device and be capable of communicating with the processor 21. In some implementations, a power supply 50 can provide power to substantially all components in the particular display device 40 design.

In this example, the display device 40 also includes a diffuser stack 100. In this example, the diffuser stack 100 includes a low-index layer and a high-index layer. In this implementation, an interface between the low-index layer and the high-index layer includes an array of microlenses of substantially randomized sizes.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays disclosed herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure-or heat-sensitive membrane. The microphone 46 can be capable of functioning as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions disclosed herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus. above-described optimization

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that can be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a first layer having a range of first layer indices of refraction, the range including at least two indices of refraction;
a second layer proximate the first layer, the second layer having a second layer index of refraction that is outside of the range of first layer indices of refraction, an interface between the first layer and the second layer including an array of microlenses of substantially randomized sizes and locations.

2. The apparatus of claim 1, wherein the microlenses include portions of the second layer that extend into the first layer, each microlens having an apex area of maximum extent into the first layer and lateral areas adjacent the apex area.

3. The apparatus of claim 2, wherein a first layer index of refraction adjacent the apex area is different from a first layer index of refraction adjacent at least a portion of the lateral areas.

4. The apparatus of claim 2, wherein a difference of index of refraction between the first layer and the second layer is relatively higher in the apex area than in at least a portion of the lateral areas.

5. The apparatus of claim 1, wherein the first layer has a first side proximate the second layer and a second side opposite the second layer, wherein surface angles of microlenses are measured from an axis normal to the second side of the first layer to a normal from a microlens surface and wherein a difference of index of refraction between the first layer and the second layer is relatively higher for lower-angled microlens surfaces, relative to a difference of index of refraction between the first layer and the second layer for higher-angled microlens surfaces.

6. The apparatus of claim 5, wherein the lower-angled microlens surfaces have surface angles between zero and a threshold angle.

7. The apparatus of claim 1, wherein the second layer index of refraction is lower than the range of first layer indices of refraction.

8. The apparatus of claim 1, further comprising a conformal anti-reflective layer between the first layer and the second layer.

9. The apparatus of claim 1, further comprising:
an array of pixels proximate the second layer; and
a substantially transparent substrate proximate the first layer.

10. The apparatus of claim 9, further comprising a cladding layer between the substantially transparent substrate and the first layer, the cladding layer having a cladding layer index of refraction that is lower than the range of first layer indices of refraction.

11. The apparatus of claim 9, wherein the substantially transparent substrate is capable of functioning as a light guide.

12. The apparatus of claim 11, wherein the light guide includes a plurality of light-extracting features capable of extracting light from the light guide and capable of providing at least a portion of the light to the array of pixels.

13. The apparatus of claim 1, wherein the first layer has a graded index of refraction.

14. A method of forming a diffuser stack, comprising:
forming, on a substantially transparent layer, a first layer having a range of first layer indices of refraction, the range including at least two indices of refraction;
etching trenches into the first layer, the trenches having substantially random sizes and locations; and
depositing a second layer proximate the first layer, the second layer having a second layer index of refraction that is outside of the range of first layer indices of refraction, to form an array of microlenses of substantially randomized sizes and locations.

15. The method of claim 14, wherein the microlenses include portions of the second layer that extend into the first layer, each microlens having an apex area of maximum extent into the first layer and lateral areas adjacent the apex area.

16. The method of claim 15, wherein a first layer index of refraction adjacent the apex area is different from a first layer index of refraction adjacent at least a portion of the lateral areas.

17. The method of claim 15, wherein a difference of index of refraction between the first layer and the second layer is relatively higher in the apex area than in at least a portion of the lateral areas.

18. The method of claim 14, wherein the first layer has a first side proximate the second layer and a second side opposite the second layer, wherein surface angles of microlenses are measured from an axis normal to the second side of the first layer to a normal from a microlens surface and wherein a difference of index of refraction between the first layer and the second layer is relatively higher for lower-angled microlens surfaces, relative to a difference of index of refraction between the first layer and the second layer for higher-angled microlens surfaces.

19. The method of claim 14, wherein second layer index of refraction is lower than the range of the first layer indices of refraction.

20. The method of claim 14, further comprising disposing a conformal anti-reflective layer between the first layer and the second layer.

21. A non-transitory medium having software stored thereon, the software including instructions for controlling one or more device to form a diffuser stack by:
forming, on a substantially transparent layer, a first layer having a range of first layer indices of refraction, the range including at least two indices of refraction;
etching trenches into the first layer, the trenches having substantially random sizes and locations; and
depositing or coating a second layer proximate the first layer, the second layer having a second layer index of refraction that is outside of the range of first layer indices of refraction, to form an array of microlenses of substantially randomized sizes and locations.

22. The non-transitory medium of claim 21, wherein the microlenses include portions of the second layer that extend into the first layer, each microlens having an apex area of maximum extent into the first layer and lateral areas adjacent the apex area.

23. The non-transitory medium of claim 22, wherein a first layer index of refraction adjacent the apex area is different from a first layer index of refraction adjacent at least a portion of the lateral areas.

24. The non-transitory medium of claim 22, wherein a difference of index of refraction between the first layer and the second layer is relatively higher in the apex area than in at least a portion of the lateral areas.

25. The non-transitory medium of claim 21, wherein the software includes instructions for forming the first layer with a graded index of refraction.

26. The non-transitory medium of claim 21, wherein the second layer index of refraction is lower than the range of first layer indices of refraction.

27. The non-transitory medium of claim 21, wherein the software includes instructions for disposing a conformal anti-reflective layer between the first layer and the second layer.

28. An apparatus, comprising:
a first layer;
a second layer proximate the first layer, an interface between the first layer and the second layer including an array of microlenses of substantially randomized sizes and locations, wherein the microlenses include portions of the second layer that extend into the first layer, each microlens having an apex area of maximum extent into the first layer and lateral areas adjacent the apex area; and
index of refraction differentiating means for making a difference of index of refraction between the first layer and the second layer relatively higher in the apex area than in at least a portion of the lateral areas.

29. The apparatus of claim 1, wherein the index of refraction differentiating means includes a range of first layer indices of refraction.

30. The apparatus of claim 29, wherein the index of refraction differentiating means includes a range of second layer indices of refraction.
